(19) United States
(12) Patent Application Publication
(10) Pub. No.: US 2006/0109402 A1
(43) Pub. Date: May 25, 2006

(54) Liquid crystal display of ocb mode and driving method of the same

(76) Inventors: Chang-Hun Lee, Kyungki-do (KR); Hak-Sun Chang, Seoul (KR)

Correspondence Address: CANTOR COLBURN, LLP, 55 GRIFFIN ROAD SOUTH, BLOOMFIELD, CT, 06002, US

(21) Appl. No.: 10/529,270

(22) PCT Filed: Nov. 5, 2002
(86) PCT No.: PCT/KR02/02056

§ 371 Date: Oct. 3, 2005

(30) Foreign Application Priority Data
Sep. 27, 2002 (KR) 200258995

(51) Int. Cl. G02F 1/1335

(52) U.S. Cl. 349/118

(57) ABSTRACT

A liquid crystal display includes a TFT array panel, a color filter panel, a liquid crystal layer aligned in OCB mode, two compensation films disposed on outer surfaces of the TFT panel and the color filter panel, respectively, and two polarization films disposed on outer surfaces of the two compensation films, respectively. The slow axes of TAC films, which are supports of the two compensation films, make an angle of 0-15 degrees with the polarization axes of the two polarization films.

### BACKGROUND OF THE INVENTION

(a) Field of the Invention

The present invention relates to an OCB (optically compensated bend) mode liquid crystal display.

(b) Description of Related Art

A typical liquid crystal display (LCD) includes an upper panel provided with a common electrode and color filters, etc., a lower panel provided with a plurality of thin film transistors (TFTs) and a plurality of pixel electrodes, etc., and a liquid crystal (LC) material interposed between the panels. The pixel electrodes and the common electrode are supplied with different voltages to generate electric field changing the orientations of LC molecules, thereby controlling light transmittance to display images.

An OCB mode LCD among the LCDs has advantages in wide viewing angle and fast response and, recently, it has been actively studied for application

However, an OCB mode LCD has a problem of low contrast ratio. It is because the OCB mode LCD gives relatively high luminance in a black state in comparison with other mode LCDs, and the high luminance in the black state is caused by the difficulty in complete compensation of the wavelength dispersion of LCD using compensation films.

### SUMMARY OF THE INVENTION

A motivation of the present invention is to improve the contrast ratio of an OCB mode LCD.

According to the present invention, slow axes of compensation films make an angle of 45-60 degrees with an alignment direction of liquid crystal molecules of a liquid crystal layer on surfaces of electrodes.

A liquid crystal display is provided, which includes: a first insulating substrate; a plurality of gate lines formed on the first insulating substrate; a plurality of data lines insulated from the gate lines and intersecting the gate lines to define a plurality of pixel areas; a plurality of pixel electrodes provided on the pixel areas; a plurality of thin film transistors connected to the gate lines, the data lines and the pixel electrodes; a second insulating substrate facing the first insulating substrate; a common electrode formed on the second insulating substrate; a liquid crystal layer interposed between the first insulating substrate and the second insulating substrate and containing a plurality of liquid crystal molecules aligned in an OCB mode; first and second compensation films provided on outer surfaces of the first and the second insulating substrate, each of the first and the second compensation film including a support and a discotic layer; and first and second polarization films provided on outer surfaces of the first and the second compensation films, wherein the slow axes of the first and the second compensation films make an angle of about 45-60 degrees with an alignment direction of the liquid crystal molecules of the liquid crystal layer on surfaces of the electrodes.

It is preferable that the polarization axes of the first and the second polarization films substantially make an angle of 45 or 135 degrees with the alignment direction of the liquid crystal molecules of the liquid crystal layer on the surfaces of the electrodes and the supports of the first and the second compensation films include TAC films.

Another liquid crystal display is provided, which includes: a first insulating substrate; a plurality of gate lines formed on the first insulating substrate; a plurality of data lines insulated from the gate lines and intersecting the gate lines to define a plurality of pixel areas; a plurality of pixel electrodes provided on the pixel areas; a plurality of thin film transistors connected to the gate lines, the data lines and the pixel electrodes; a second insulating substrate facing the first insulating substrate; a common electrode formed on the second insulating substrate; a liquid crystal layer interposed between the first insulating substrate and the second insulating substrate and containing a plurality of liquid crystal molecules aligned in splay in absence of electric field between the pixel electrodes and the common electrode; first and second compensation films provided on outer surfaces of the first and the second insulating substrate, each of the first and the second compensation film including a support and a discotic layer; and first and second polarization films provided on outer surfaces of the first and the second compensation films, wherein the slow axes of the first and the second compensation films make an angle of 0-15 degrees with the polarization axis of one of the first and the second polarization films.

Preferably, the liquid crystal molecules of the liquid crystal layer are in splay alignment when no electric field is applied between the pixel electrodes and the common electrode, and the slow axes of the first and the second compensation films substantially make an angle of 45-40 degrees with the alignment direction of the liquid crystal molecules of the liquid crystal layer on surfaces of the electrodes. The supports of the first and the second compensation films preferably include TAC films.

The data lines may include three layers of a metal layer, an amorphous silicon layer, and a doped amorphous silicon layer doped with n type impurity, which preferably have substantially the same layout.

### BRIEF DESCRIPTION OF THE DRAWINGS

FIG. 1A is a layout view of an LCD according to a first embodiment of the present invention;

FIG. 1B is a sectional view of the LCD shown in FIG. 1A according to the first embodiment of the present invention taken along the line IB-IB′;

FIG. 2A is a layout view of an LCD according to a second embodiment of the present invention;

FIG. 2B a sectional view of the LCD shown in FIG. 2A according to the second embodiment of the present invention taken along the line IIB-IIB′;

FIG. 3 is a detailed sectional view of an exemplary compensation film utilizable in the first and the second embodiments of the present invention.

FIG. 4 illustrates the refractive anisotropy of a light transmitting medium when viewing from the front of an OCB mode LCD;

FIG. 5 is a Poincare Sphere illustrating the polarization experienced by light passing through an OCB mode LCD in the black state;

FIG. 6 illustrates polarizations of red, green and blue lights when the wavelength dispersion of a LC layer is larger than the wavelength dispersion of compensation films;

FIG. 7 illustrates polarizations of red, green and blue lights when the wavelength dispersion of a LC layer is smaller than the wavelength dispersion of compensation films;

FIG. 8 is a graph showing retardation as function of light wavelength in an OCB mode LCD upon application of a voltage near a black voltage when the wavelength dispersion of a LC layer is smaller than the wavelength dispersion of compensation films;

FIGS. 9A, 10A, 11A, 12A, 13A, and 14A illustrate arrangements of a slow axis of a support and a rubbing direction in relation to a polarization axis in cases that the slow axis is parallel to the rubbing direction, makes an angle of 10, 30, 45, 60 and 75 degrees with the rubbing direction, respectively; and

FIGS. 9B, 10B, 11B, 12B, 13B, and 14B are graphs showing dispersions of minimum luminance voltages for red, green, and blue colors in the arrangements shown in FIGS. 9A, 10A, 11A, 12A, 13A and 14A, respectively.

### DETAILED DESCRIPTION OF THE PREFERRED EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present

Now, liquid crystal displays according to embodiments of the present invention will be described with reference to the accompanying drawings.

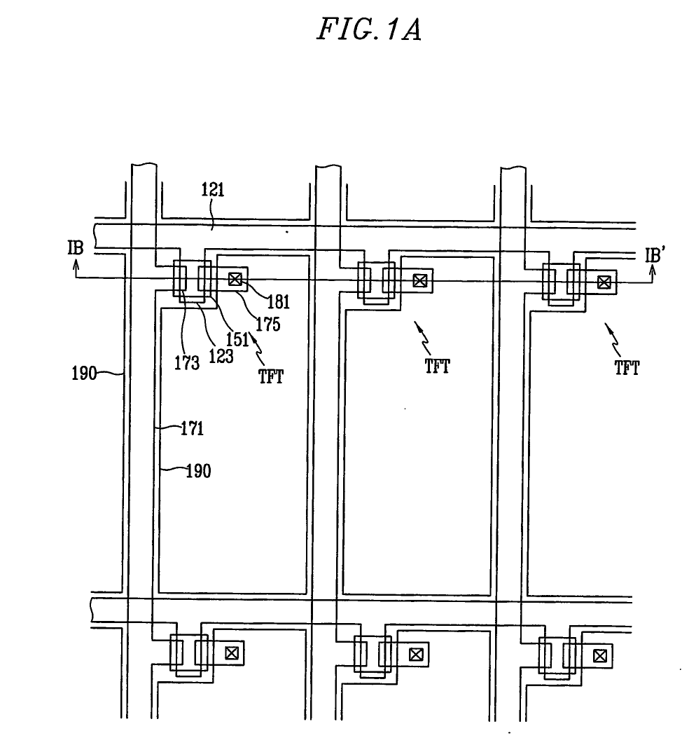

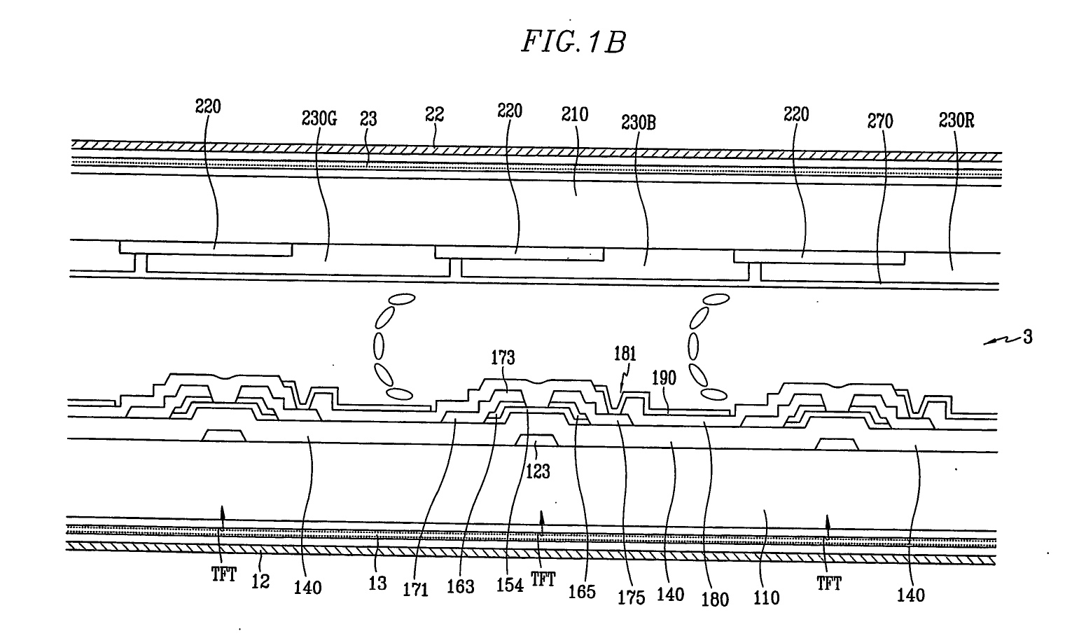

FIG. 1A is a layout view of LCDs according to first and second embodiments of the present invention, and FIG. 1B is a sectional view of the LCD according to the first embodiment of the present invention taken along the line IB-IB′ shown in FIG. 1A.

An OCB mode LCD according to this embodiment includes a TFT array panel, a color filter panel, a LC layer 3 interposed between the panels, a pair of compensation fills 13 and 23 attached to outer surfaces of the panels, and a pair of polarization films 12 and 22 attached to outer surfaces of the compensation films 13 and 23.

A TFT array panel is described now.

A gate wire 121 and 123 preferable made of conductive material such as Al, Al alloy, Cr, Cr alloy, Mo, Mo alloy, Cr nitride, and Mo nitride and having thickness of 1,000-3,500 Å is formed on an insulating substrate 110.

The gate wire 121 and 123 includes a plurality of gate lines 121 extending in a transverse direction and a plurality of gate electrodes 123 branched from the gate lines 121.

The gate wire 121 and 123 may have a multi-layered structure including at least two layers, and it is preferred that the multi-layered structure includes at least one layer made of metal having low resistivity.

A gate insulating layer 140 formed on the substrate 110, preferably made of silicon nitride or silicon oxide, and having thickness of 3,500-4,500 Å covers the gate wire 121 and 123.

A semiconductor pattern 154 having thickness of 800-1,500 Å, is formed on the gate insulating layer 140. The semiconductor pattern 154 is preferably made of amorphous silicon and overlaps a plurality of gate electrodes 123. An ohmic contact layer 163 and 165 is formed on the semiconductor pattern 154. The ohmic contact layer 163 and 165 is preferably made of amorphous silicon doped with N type impurity and has a thickness of 500-800 Å.

A data wire 171, 173 and 175 is formed on the ohmic contact layer 163 and 165 and the gate insulating layer 140. The data wire 171, 173 and 175 is preferably made of conductive material such as Al, Al alloy, Cr, Cr alloy, Mo, Mo alloy, Cr nitride, and Mo nitride and has a thickness of 1,500-3,500 Å.

The data wire 171, 173 and 175 includes a plurality of data lines 171 extending in a longitudinal direction and intersecting the gate lines 121 to define a plurality of pixel areas, a plurality of source electrodes 173 branched from the data lines 171 and extending onto one portions 163 of the ohmic contact layer, and a plurality of drain electrodes 175 facing the source electrodes 173, extending from the other portions 165 of the ohmic contact layer to portions of the gate insulating layer 140 in the pixel areas.

The data wire 171, 173 and 175 may have a multi-layered structure including at least two layers, and it is preferred that the multi-layered structure includes at least one layer made of metal having low resistivity.

The data wire 171, 173 and 175 and the semiconductor pattern 154 are covered with a passivation layer 180 made of insulating material such as silicon nitride and silicon oxide and having a thickness of 1,500-2,500 Å.

A plurality of pixel areas defined by intersections of the gate lines 121 and a plurality of data lines 171 includes a plurality of red, green and blue pixel areas facing red, green and blue color filters R, G and B, respectively, which will be described later.

The passivation layer 180 has a plurality of contact holes 181 exposing the drain electrodes 175, and a plurality of pixel electrodes 190 connected to the drain electrodes 175 through the contact holes 181 are formed on the passivation layer 180. The pixel electrodes 190 are made of transparent conductive material such as lTO and IZO.

The color filter panel facing the TFT array panel is described now.

A black matrix 220 facing portions of the gate lines 121, the data lines 171, and the TFrs of the TFT array panel is formed on a second insulating substrate 210.

A plurality of red color filters R, a plurality of green color filters G, and a plurality of blue color filters B are formed in sequence on parts of the second the substrate 210 and the black matrix 220.

Entire Surface of the panel including the red, the green and the blue color filters R, G and B is covered with a common electrode 270 made of ITO or IZO.

The color filter panel and the TFT array panel are assembled with a predetermined gap therebetween.

The LC layer is aligned in an OCB (optically compensated bend) mode, which aligns nematic LC in splay state, converts the alignment state into bend stat by applying a predetermined voltage, and adjusts applied voltages to control light transmittance. For this purpose, alignment films (not shown) are formed on a surface of pixel electrode 190 and on a surface of the common electrode 270 and rubbed to align the LC molecules in a predetermined direction. Here, the rubbing directions for the surface of the pixel electrode 190 and that for the common electrode 270 are the same for splay alignment.

The polarizing axes of the polarization films 12 and 22 are crossed and make an angle of about 45 degrees or 135 degrees with the rubbing direction of the alignment layers.

The compensation films 13 and 23 are adjusted so that compensation characteristic is optimized for the green light. Each compensation film 13 or 23 includes a discotic layer and a support therefor such as a TAC (triacetate cellulose) film The TAC film the support of the compensation film, has refractive anisotropy, and is disposed such that the slow axis of TAC film makes an angle of about 45-60 degrees with the rubbing direction of the alignment films (i.e., the alignment direction of the LC). Therefore, the slow axis of the TAC film make an angle of about 0-15 degrees with the polarization axes of the two polarization films 13 and 23.

As described above, if the slow axis of the compensation film is adjusted to make an angle of about 45-60 degrees with the alignment direction of the LC, the support also performs a function of compensating the wavelength dispersion of the LC to reduce the dispersion of minimum luminance voltages of red, green, and blue colors. This decreases the luminance of the black state to increase the contrast ratio.

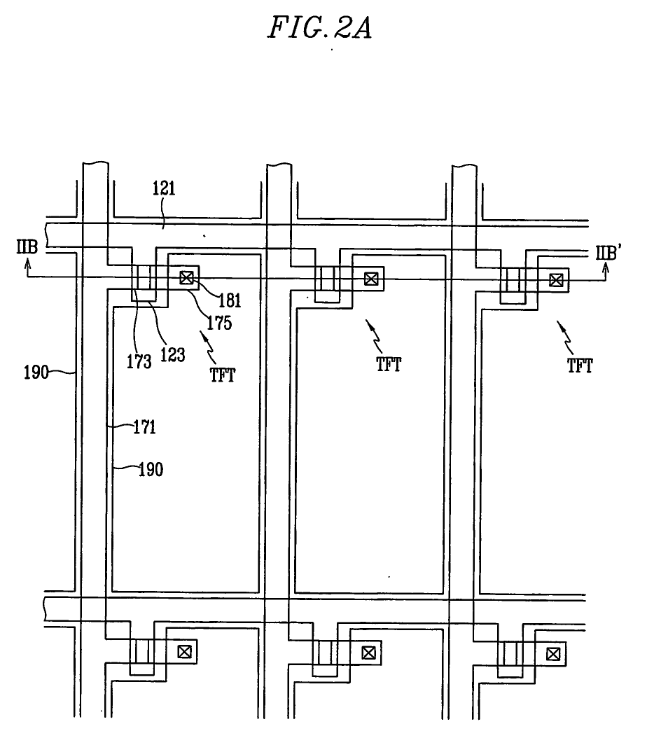

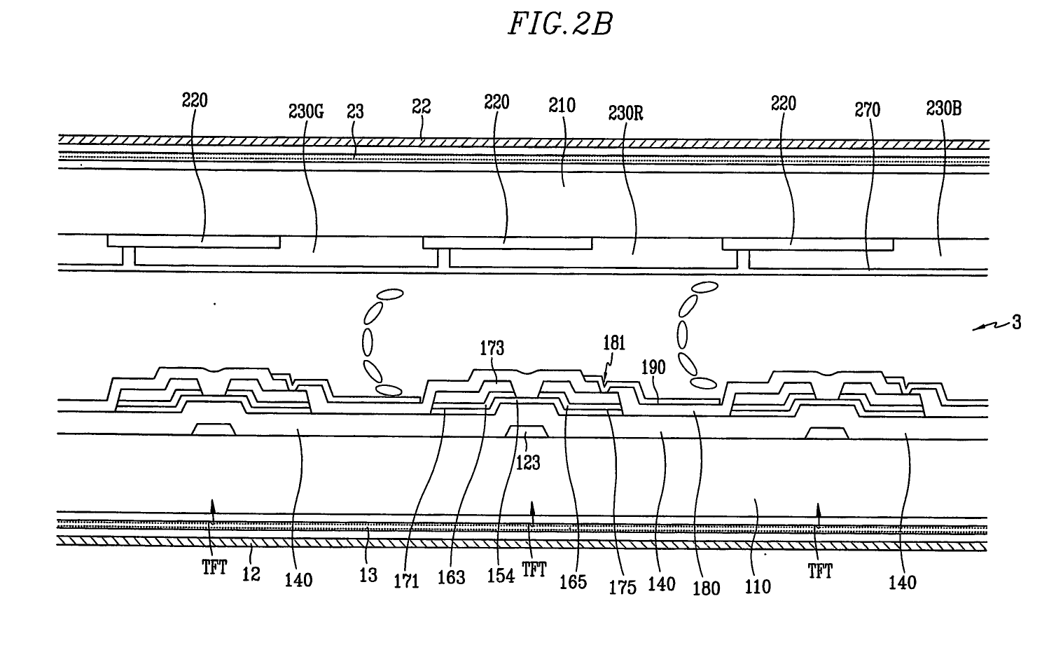

FIG. 2A is a layout view of an LCD according to a second embodiment of the present invention, and FIG. 2B is a sectional view of an LCD shown in FIG. 2A taken along the line IIB-IIB′.

An LCD according to the second embodiment of the present invention has substantially the same structure except for a TFT panel. Then, the second embodiment will now be described focusing on the differences therebetween

According to the second embodiment, a data wire 171, 173 and 175 and an ohmic contact layer 163 and 165 have substantially the same layout, and a semiconductor layer 154 also has substantially the same layout as the data wire 171, 173 and 175 except that a portion of the semiconductor layer 154 between a source electrode 173 and a drain electrode 175 is connected. In other words, the data wire includes triple layers of a metal layer 171, 173 and 175, an amorphous silicon layer 163 and 165 doped with n type impurity, and an amorphous silicon layer 154, and these three layers have substantially the same layout.

This feature is resulted from a patterning process forming the data wire 171, 173 and 175, the ohmic contact layer 163 and 165, and the semiconductor layer 154 using one photolithography process during a manufacturing process of the TFT panel. That is, after leaving thick portions of a photoresist on portions which become the data wire 171, 173 and 175 and a thin portions of the photoresist on portions between the source electrodes 173 and the drain electrodes 175 using half-ton light exposure, a data metal layer, an ohmic contact layer and a semiconductor layer under the photoresist are etched using the photoresist as an etching mask. The etching process is now described.

Exposed portions of the data metal layer are etched first, and underlying portions of the ohmic contact layer and of the semiconductor layer are etched in sequence. In this step, the photoresist is partially etched to expose portions of the data metal layer between the source electrodes 173 and the drain electrodes 175, which were covered with the thin portions of the photoresist Photoresist residue remaining between the source electrodes 173 and the drain electrodes 175 is removed completely by ashing the photoresist, and exposed portions of the data metal layer and underlying portions of the ohmic contact layer are sequentially etched. In this way, a TFT panel according to the second embodiment of the present invention can be obtained.

A structure of a color filter panel, arrangements of compensation films and polarization films, alignment of LC, etc. are substantially the same as the LCD according to the first embodiment of the present invention. Therefore, the effect increasing the contrast ratio by reducing the diversity of minimum luminance voltages of red, green, and blue colors to decrease the black luminance is apparent like the first embodiment.

Next, the compensation films 13 and 23 used in the first and the second embodiments are described in more detail.

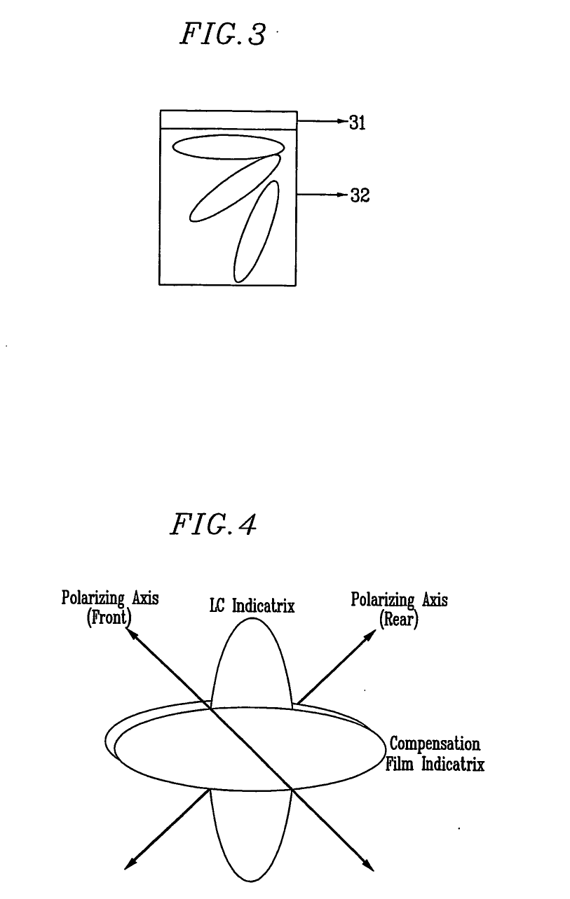

FIG. 3 is a detailed sectional view of an exemplary compensation film utilizable in the first and the second embodiments of the present invention.

A compensation film 13 or 23 for the present invention includes a support 31 and a discotic layer 32. The support 31 is provided for maintaining morphology of the compensation film 13 or 23 and preferably made of a TAC film. The discotic layer 32 is a compensation layer having a hybrid configuration for compensating the effect of the liquid crystal aligned in a hybrid.

Although the main function of the support 31 is to maintain the morphology of the compensation film 13 or 23, the support 31 having some arrangements may influence light polarization because the support itself also has refractive anisotropy. The present invention confirms that the support 31 compensates the wavelength dispersion of the liquid crystal, and it also presents optimal arrangements of the support 31 for the wavelength dispersion compensation.

The reason why some arrangements of the support of the compensation film 13 or 23 improves the contrast ratio will be described in detail.

First, the reason why the luminance of the black gray in the OCB mode is higher than that in the other modes is described.

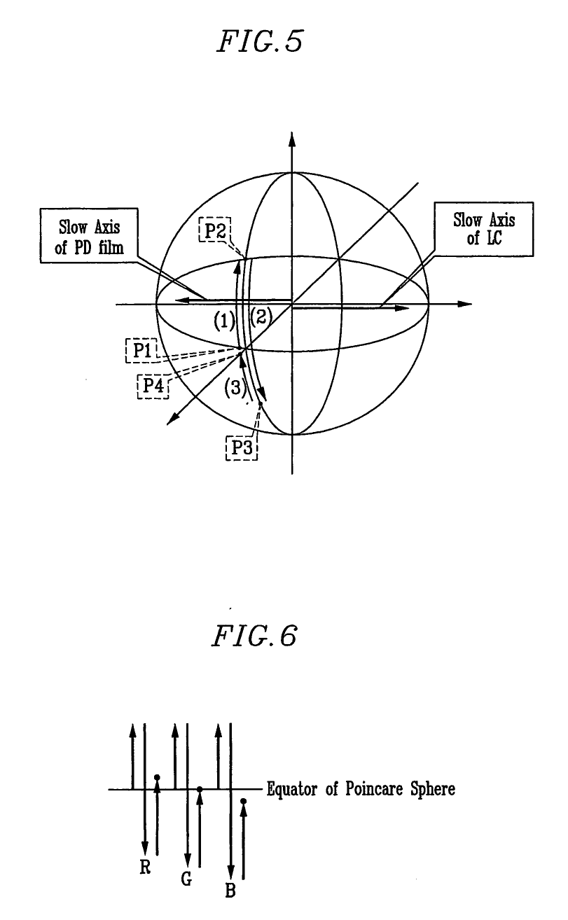

FIG. 4 illustrates the refractive anisotropy of a light transmitting medium when viewing from the front of an OCB mode LCD, and FIG. 5 is a Poincare Sphere illustrating the polarization experienced by light passing through an OCB mode LCD in the black state.

When a light passes through an LCD, as shown in FIG. 4, the polarization of the light after being linearly polarized by the polarizing film 12 is changed by the indicatrix of the compensation film 13, and then changed by the indicatrix of a LC layer 3. Subsequently, the light is linearly polarized by the polarizing film 22.

The change of the polarization is illustrated in a Poincare Sphere shown in FIG. 5.

The polarization of the light linearly polarized by the polarizing film 12 is located on the equator P1 of the Sphere, and the left-handed elliptical polarization of the light after passing through a phase difference film, Le., the compensation film 13 is located on a point P2 deviated from the equator and moved toward the North Pole. The light passing through the LC layer 3 has the right-handed elliptical polarization located on a point P3 deviated from the equator and moved toward the South Pole and, finally, the polarization of the light becomes linear again by a phase difference film, ie., the compensation film 23 to be located on the equator P4.

The final linear polarization of the light after passing through the compensation films 13 and 23 and the LC layer 3 means the completion of compensation preventing light leakage. In the meantime, the refractive anisotropy of the LC layer 3 and the compensation films 13 and 23 depends on the wavelength of light, which is called the wavelength dispersion. The difference between the wavelength dispersion of the LC layer 3 and the wavelength dispersion of the compensation films 13 and 23 prevents perfect compensation for all colors.

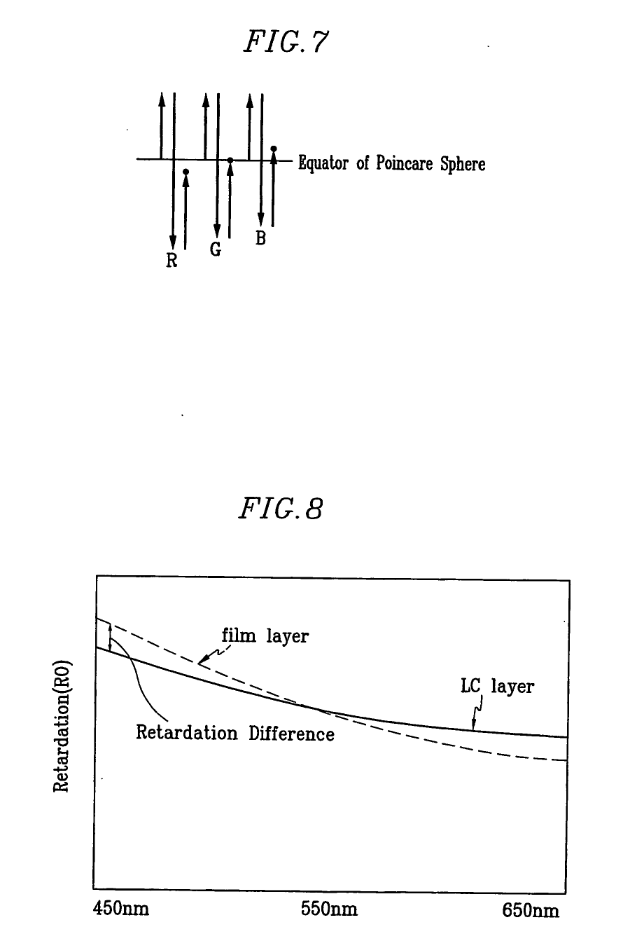

FIG. 6 illustrates polarizations of red, green and blue lights when the wavelength dispersion of a LC layer is larger than the wavelength dispersion of compensation films, and FIG. 7 illustrates polarizations of red, green and blue lights when the wavelength dispersion of a LC layer is smaller than the wavelength dispersion of compensation films.

Referring to FIG. 6, when the wavelength dispersion of a LC layer is larger than the wavelength dispersion of the compensation films and the compensation films are optimized such that the compensation for the green light is maximized, the red light is over-compensated while the blue light under-compensated, by the compensation films such that their polarizations cannot not become perfectly linear.

On the contrary, when the wavelength dispersion of a LC layer is smaller than the wavelength dispersion of the compensation films and the compensation films are optimized such that the compensation for the green light is maximized, the red light is under-compensated and the blue light over-compensated by the compensation films such that their polarization cannot become perfectly linear as shown in FIG. 7.

Accordingly, perfect compensation is not expected to be made for all lights with different wavelengths unless the wavelength dispersion of the LC layer coincides with the wavelength dispersion of the compensation films. Although it is preferred in a typical reflective LCD that the wavelength dispersion of LC is reversed to the wavelength dispersion of the compensation films, it is preferred in an OCB mode LCD that the wavelength dispersion of LC is close to the wavelength dispersion of the compensation films. That is, the difference of the retardation depending upon the light wavelength between the compensation films and LC is preferably minimized.

A case that the wavelength dispersion of the LC layer is smaller than the wavelength dispersion of the compensation films is described more in detail.

FIG. 8 is a graph showing retardation as function of light wavelength in an OCB mode LCD upon application of a voltage near a black voltage when the wavelength dispersion of a LC layer is smaller than the wavelength dispersion of compensation films.

Since the wavelength dispersion of the compensation films and LC for red, green and blue wavelengths is different, the retardation is different for blue (i.e., short wavelength) and red (i.e., long wavelength) when the compensation is made for red, as shown in FIG. 8. For the blue light, the front retardation (d(Nx−Ny)×2) of the compensation films is larger than that of LC and thus the compensation is incomplete. On the contrary, the front retardation (d(Nx−Ny)×2) of the compensation films for the red light is smaller than that of LC and thus the compensation is incomplete.

According to experiments, it was confirmed that the difference in the wavelength dispersion between a compensation film and a liquid crystal increases or decreases depending on the direction of the slow axis of a support of the compensation film 13 or 23. In particular, it was confirmed through the experiments that the diversity of the minimum luminance voltages of red, green, and blue lights could be reduced by adjusting the angle between the slow axis of the support and the rubbing direction of an alignment layer (i.e., the alignment direction of the liquid crystal on a surface of a electrode), and the optimum angle was verified to be between about 45 and 60 degrees.

Now, the experiments are described using graphs.

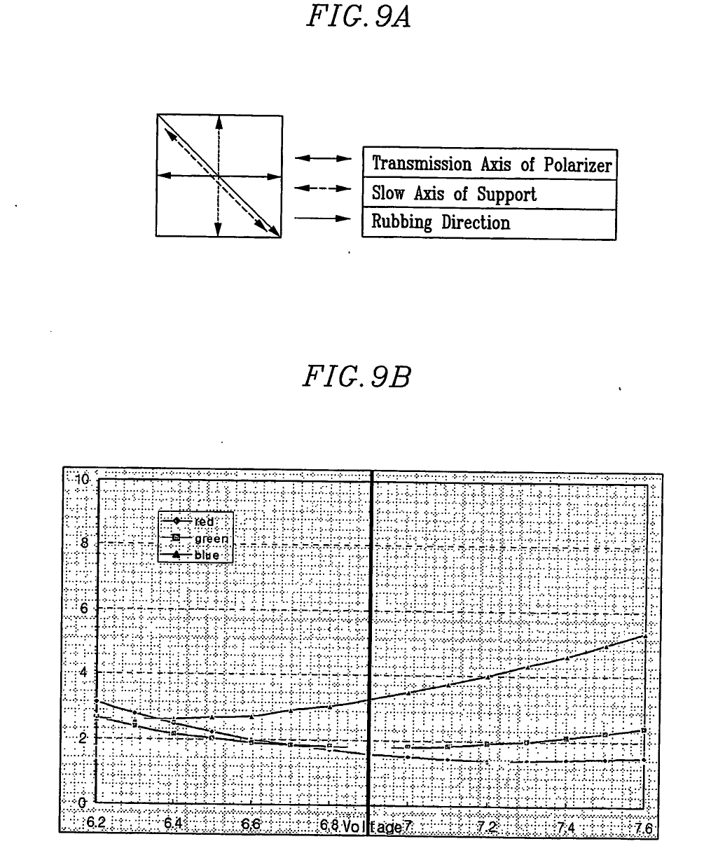

FIGS. 9A, 10A, 11A, 12A, 13A, and 14A illustrate arrangements of a slow axis of a support and a rubbing direction in relation to a polarization axis in cases that the slow axis is parallel to the rubbing direction and makes an angle of 10, 30, 45, 60 and 75 degrees with the rubbing direction, respectively. FIGS. 9B, 10B, 11B, 12B, 13B, and 14B are graphs showing dispersions of minimum luminance voltages for red, green, and blue colors in the arrangements shown in FIGS. 9A, 10A, 11A, 12A, 13A and 14A, respectively.

As shown in FIGS. 9A and 9B, in case that the slow axis of the support is parallel to the rubbing direction, the black voltage set on the basis of green color was 6.9V, the minimum luminance voltage for blue color was 6.2V, and the minimum luminance voltage for red color was 7.2V. Therefore, the difference in the minimum luminance voltage between blue and red is almost 1V.

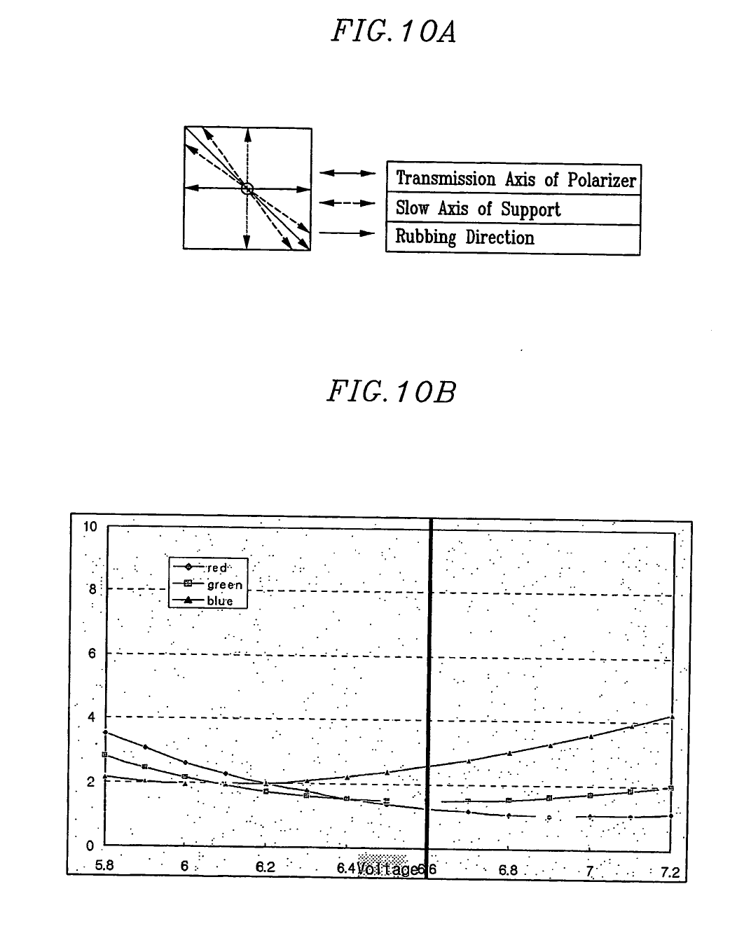

As shown in FIGS. 10A and 10B, in case that the slow axis of the support makes an angle of 10 degrees with the rubbing direction, the black voltage set on the basis of green color was 6.6V, the minimum luminance voltage for blue color was 6.1V, and the minimum luminance voltage for red color was 6.9V. Therefore, the difference in the minimum luminance voltage between blue and red is reduced a little up to 0.8V.

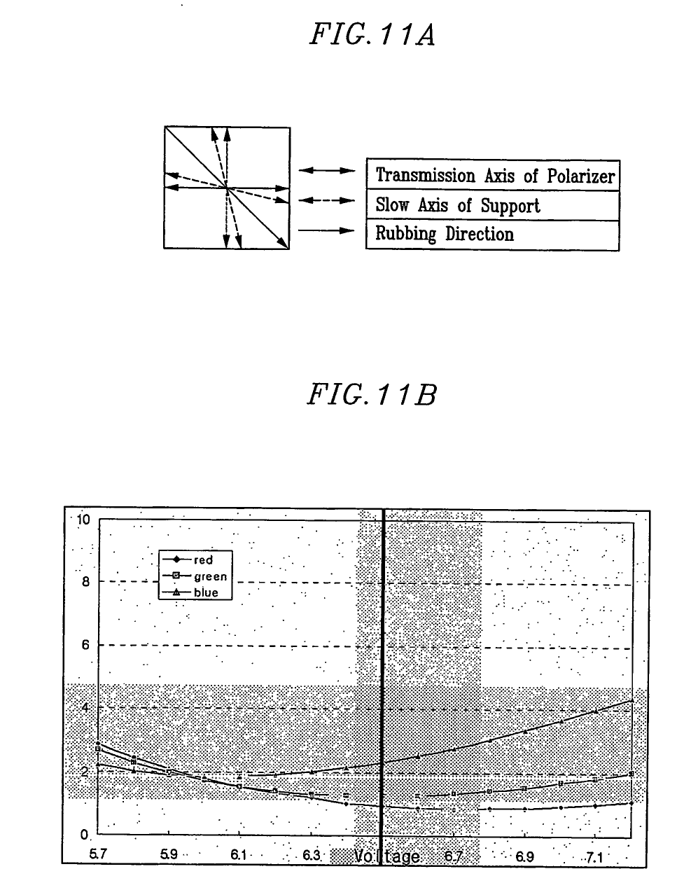

As shown in FIGS. 11A and 11B, in case that the slow axis of the support makes an angle of 30 degrees with the rubbing direction, the black voltage set on the basis of green color was 6.5V, the minimum luminance voltage for blue color was 6.0V, and the minimum luminance voltage for red color was 6.7V. Therefore, the difference in the minimum luminance voltage between blue and red is reduced up to 0.7V.

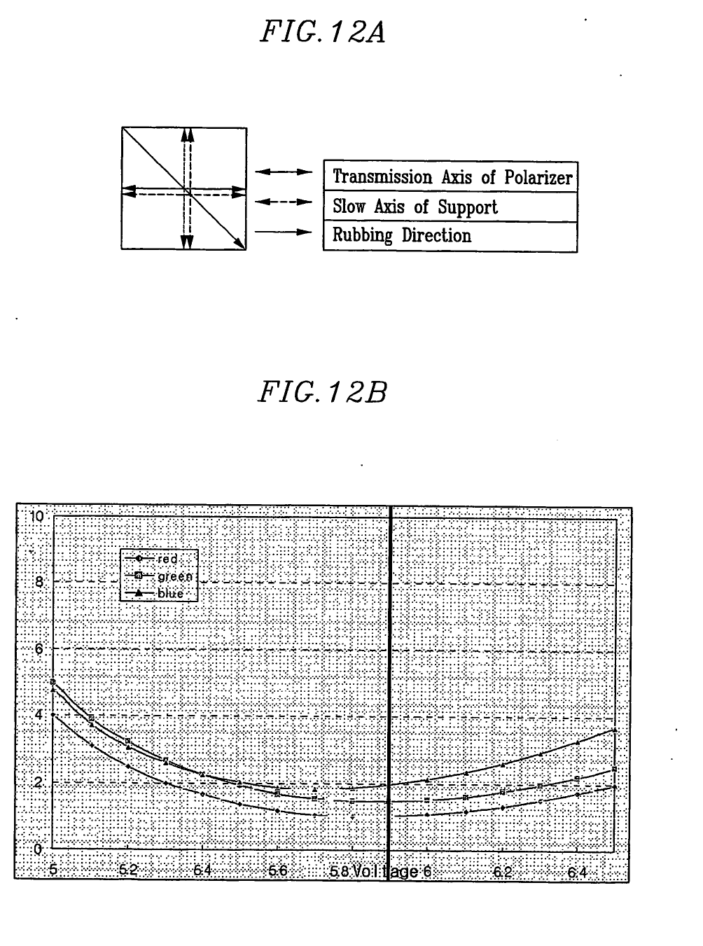

As shown in FIGS. 12A and 12B, in case that the slow axis of the support makes an angle of 45 degrees with the rubbing direction, the black voltage set on the basis of green color was 5.8V, the minimum luminance voltage for blue color was 5.7V, and the minimum luminance voltage for red color was 5.9V. Therefore, the difference in the minimum luminance voltage between blue and red is reduced up to 0.2V.

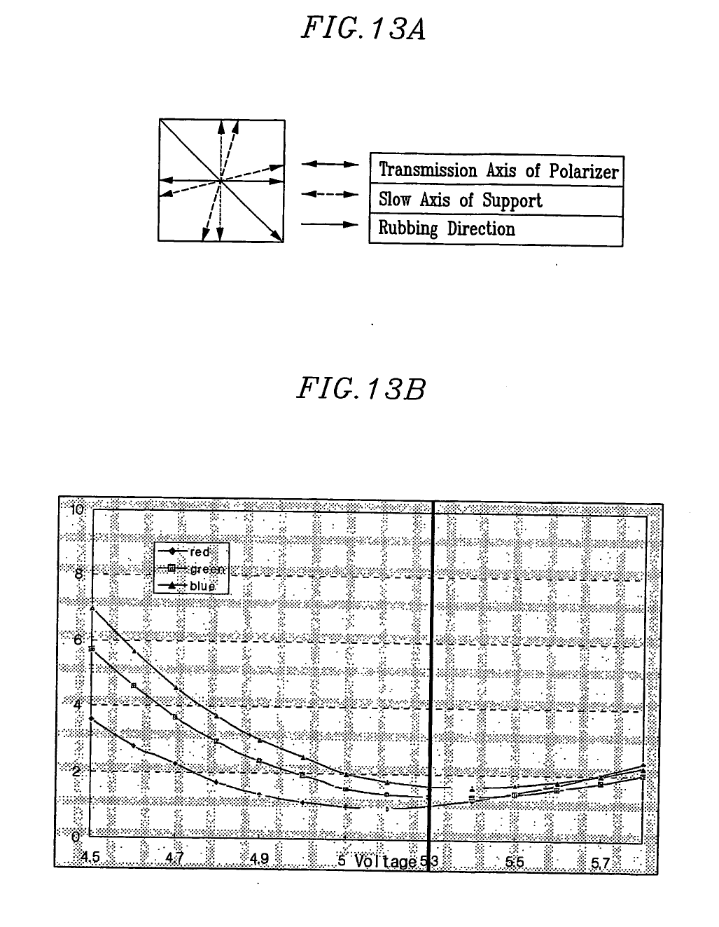

As shown in FIGS. 13A and 13B, in case that the slow axis of the support makes an angle of 60 degrees with the rubbing direction, the black voltage set on the basis of green color was 5.3V, the minimum luminance voltage for blue color was 5.4V, and the minimum luminance voltage for red color was 5.2V. Therefore, the difference in the minimum luminance voltage between blue and red is maintained to 0.2V.

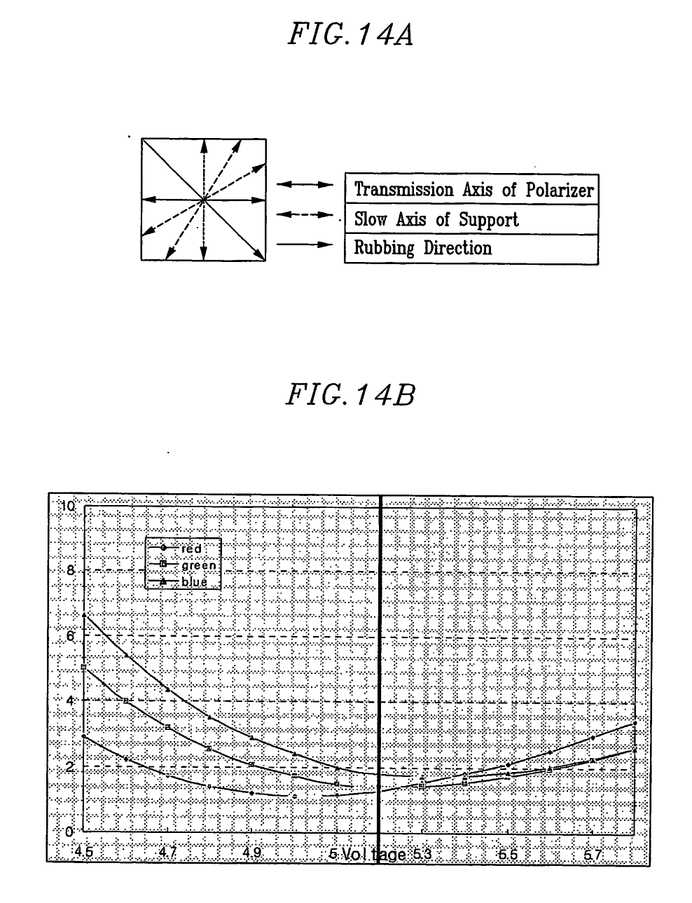

As shown in FIGS. 14A and 14B, in case that the slow axis of the support makes an angle of 75 degrees with the rubbing direction, the black voltage set on the basis of green color was 5.2V, the minimum luminance voltage for blue color was 5.3V, and the minimum luminance voltage for red color was 5.0V. Therefore, the difference in the minimum luminance voltage between blue and red increased up to 0.3V while the minimum luminance voltage for red color became lower than the minimum luminance voltage for blue color.

According to the above described experiments, the dispersion of the minimum luminance voltages of red, green, and blue lights decreases as the angle between the slow axis of the support and the rubbing direction increases, reaches a minimum value for the angle between about 52 and 53 degrees, and increases again as the angle increases while the minimum luminance voltages for red and blue are reversed. Therefore, we can conclude that the optimal angle between the slow axis of the support and the rubbing direction of an OCB mode LCD is in a range between 45 and 60 degrees, which gives the difference between the minimum luminance voltages for red and blue equal to or less than 0.2V.

As described above, if the slow axis of the support of the compensation film is arranged to make an angle of 45-60 degrees with the alignment direction of the liquid crystal, the support also has a function of compensating the wavelength dispersion of the liquid crystal to decrease the dispersion of the minimum luminance voltages for red, green, and blue colors. Then, the contrast ratio is improved by reducing the luminance of the black state.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

What is claimed is:

1. A liquid crystal display comprising:
a first insulating substrate;
a plurality of gate lines formed on the first insulating substrate;
a plurality of data lines insulated from the gate lines and intersecting the gate lines to define a plurality of pixel areas;
a plurality of pixel electrodes provided on the pixel areas;
a plurality of thin film transistors connected to the gate lines, the data lines and the pixel electrodes;
a second insulating substrate facing the first insulating substrate;
a common electrode formed on the second insulating substrate;
a liquid crystal layer interposed between the first insulating substrate and the second insulating substrate and containing a plurality of liquid crystal molecules aligned in an OCB mode;
first and second compensation films provided on outer surfaces of the first and the second insulating substrate, each of the first and the second compensation film including a support and a discotic layer; and
first and second polarization films provided on outer surfaces of the first and the second compensation films,
wherein the slow axes of the first and the second compensation films make an angle of about 45-60 degrees with an alignment direction of the liquid crystal molecules of the liquid crystal layer on surfaces of the electrodes.

2. The liquid crystal display of claim 1, wherein the polarization axes of the first and the second polarization films substantially make an angle of 45 or 135 degrees with the alignment direction of the liquid crystal molecules of the liquid crystal layer on the surfaces of the electrodes.

3. The liquid crystal display of claim 1, wherein the supports of the first and the second compensation films include TAC films.

4. A liquid crystal display comprising:
a first insulating substrate;
a plurality of gate lines formed on the first insulating substrate;
a plurality of data lines insulated from the gate lines and intersecting the gate lines to define a plurality of pixel areas;
a plurality of pixel electrodes provided on the pixel areas;
a plurality of thin film transistors connected to the gate lines, the data lines and the pixel electrodes;
a second insulating substrate facing the first insulating substrate;
a common electrode formed on the second insulating substrate;
a liquid crystal layer interposed between the first insulating substrate and the second insulating substrate and containing a plurality of liquid crystal molecules aligned in splay in absence of electric field between the pixel electrodes and the common electrode;
first and second compensation films provided on outer surfaces of the first and the second insulating substrate, each of the first and the second compensation film including a support and a discotic layer; and
first and second polarization films provided on outer surfaces of the first and the second compensation films,
wherein the slow axes of the first and the second compensation films make an angle of 0-15 degrees with the polarization axis of one of the first and the second polarization films.

5. The liquid crystal display of claim 4, wherein the liquid crystal molecules of the liquid crystal layer are in splay alignment when no electric field is applied between the pixel electrodes and the common electrode, and the slow axes of the first and the second compensation films substantially make an angle of 45-60 degrees with the alignment direction of the liquid crystal molecules of the liquid crystal layer on surfaces of the electrodes.

6. The liquid crystal display of claim 4, wherein the supports of the first and the second compensation films include TAC films.

7. The liquid crystal display of claim 4, wherein the data lines comprise three layers of a metal layer, an amorphous silicon layer, and a doped amorphous silicon layer doped with n type impurity.

8. The liquid crystal display of claim 7, wherein the metal layer, the amorphous silicon layer, and the doped amorphous silicon layer forming the data lines have substantially the same layout.
